(19) United States
(12) Patent Application Publication
(10) Pub. No.: US 2009/0022488 A1
(43) Pub. Date: Jan. 22, 2009

(54) CAMERA

(75) Inventors: Atsushi KOHASHI, Tokyo (JP); Tomomi HIRANO, Tokyo (JP); Hideki NAGATA, Tokyo (JP); Hideru IKEDA, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: OLYMPUS CORPORATION, Tokyo (JP)

(21) Appl. No.: 12/174,041

(22) Filed: Jul. 16, 2008

(30) Foreign Application Priority Data
Jul. 20, 2007 (JP) 2007-189862

(51) Int. Cl. G03B 17/00

(52) U.S. Cl. 396/265

(57) ABSTRACT

The invention makes it is possible to easily and precisely adjust the frame rate of continuous shooting photography, and to keep it constant for a long period of time. The invention provides a digital camera including an image-acquisition device for acquiring an image of a subject; a shutter control member operated in a direction along a front surface of a casing during continuous shooting photography; a sensor for detecting a control level or operating force of the shutter control member; and an overall controller for adjusting a frame rate of the continuous shooting photography performed by the image-acquisition device on the basis of the control level or operating force detected by the sensor.

### BACKGROUND OF THE INVENTION

1. Field of the Invention

The present invention relates to cameras.

This application is based on Japanese Patent Application No. 2007-189862, the content of which is incorporated herein by reference.

2. Description of Related Art

A known camera in the related art performs continuous image acquisition at time intervals in inverse proportion to the degree of pressing of a shutter release switch during continuous shooting photography (see Japanese Unexamined Patent Application, Publication No. 2006-162725).

With this camera, when acquiring an image of a violently moving subject, it is possible to acquire more images merely by increasing the degree of pressing of a button-type shutter release switch according to the intensity of the subject's motion, which improves the chances of acquiring a desired image.

### BRIEF SUMMARY OF THE INVENTION

An object of the present invention is to provide a camera in which it is possible to easily and precisely adjust the frame rate of continuous shooting photography, and to keep it constant for a long period of time.

The present invention employs the following solutions.

One aspect of the present invention is a camera including an image-acquisition device configured to acquire an image of a subject; a shutter control member operated in a direction parallel to a front surface of a casing during continuous shooting photography; a detector configured to detect a control level or operating force of the shutter control member; and a control unit configured to adjust a frame rate of the continuous shooting photography by the image-acquisition device on the basis of the control level or operating force detected by the detector.

With this aspect of the invention, when performing continuous shooting photography, by operating the shutter control member, the control level or operating force is detected by the detector and the frame rate (the number of acquired frames per second) of the continuous shooting performed by the image-acquisition device is adjusted on the basis thereof.

In this case, because the shutter control member is operated in a direction along the front surface of the casing, it is possible to ensure a large stroke in the operating direction as compared with operating the shutter control member in a direction perpendicular to the front surface of the casing, as with a push button or the like. As a result, it is possible to easily and precisely adjust the frame rate.

By forming the shutter control member alongside the front surface, part of the finger used to operate it is made to contact the front surface of the casing, thus augmenting the operating force from the finger with the friction thereof, which facilitates fine adjustment and allows the shutter control member to be firmly held.

In the aspect described above, the detector may detect the control level of the shutter control member; and the shutter control member may include a control-level maintaining unit configured to maintain the control level.

With this configuration, by operating the control-level maintaining unit, the control level of the shutter control member detected by the detector is maintained. Therefore, it is possible to keep the frame rate constant even if the user's hand is removed from the shutter control member. As a result, it is possible to perform continuous shooting photography with a stable frame rate setting, even though the shutter control member is not continuously operated.

In the aspect described above, the shutter control member may be a dial that is capable of rotating about an axis substantially orthogonal to the front surface of the casing.

In the aspect described above, the shutter control member may be a stick that is capable of rocking about an axis substantially parallel to the front surface of the casing.

In the aspect described above, the shutter control member may be a slider.

Advantages of the present invention are the ability to easily and precisely adjust the frame rate of continuous shooting photography and the ability to keep it constant for a long period of time.

### BRIEF DESCRIPTION OF THE SEVERAL VIEWS OF THE DRAWINGS

FIG. 1 is a top view of a digital camera according to a first embodiment of the present invention.

FIG. 2 is a rear view of the digital camera in FIG. 1.

FIG. 3 is an enlarged view of a frame-rate dial on the digital camera in FIG. 1.

FIG. 4 is a block diagram of the internal configuration of the digital camera in FIG. 1.

FIG. 5 is a flowchart showing the operation of the digital camera in FIG. 1 during continuous shooting photography.

FIG. 6 is a top view of a digital camera according to a second embodiment of the present invention.

FIG. 7 is a rear view of the digital camera in FIG. 6.

FIG. 8 is an enlarged view of a frame-rate stick on the digital camera in FIG. 6.

FIG. 9 is a flowchart showing the operation of the digital camera in FIG. 6 during continuous shooting photography.

### DETAILED DESCRIPTION OF THE INVENTION

### First Embodiment

A digital camera (camera) according to a first embodiment of the present invention will be described below with reference to the drawings.

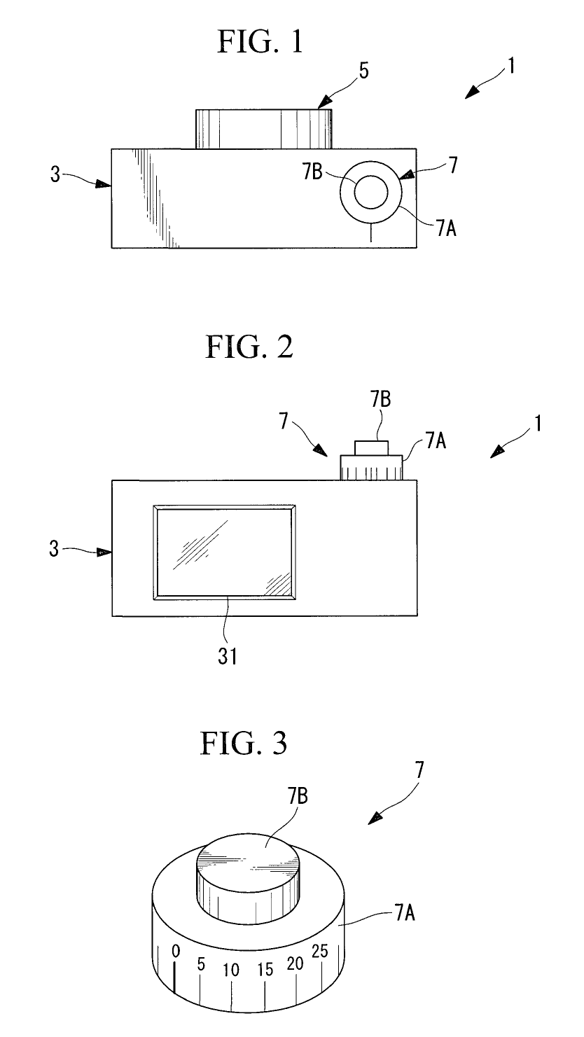

As shown in FIGS. 1 to 3, a digital camera 1 according to this embodiment includes a camera body (casing) 3 formed in a substantially rectangular block shape; a lens unit 5 provided on the front face of the camera body 3 so as to be extendible therefrom and focusing external light to form an image of a subject; and a shutter control member 7 provided on the top surface of the camera body 3 for performing an operation to acquire an image via the lens unit 5.

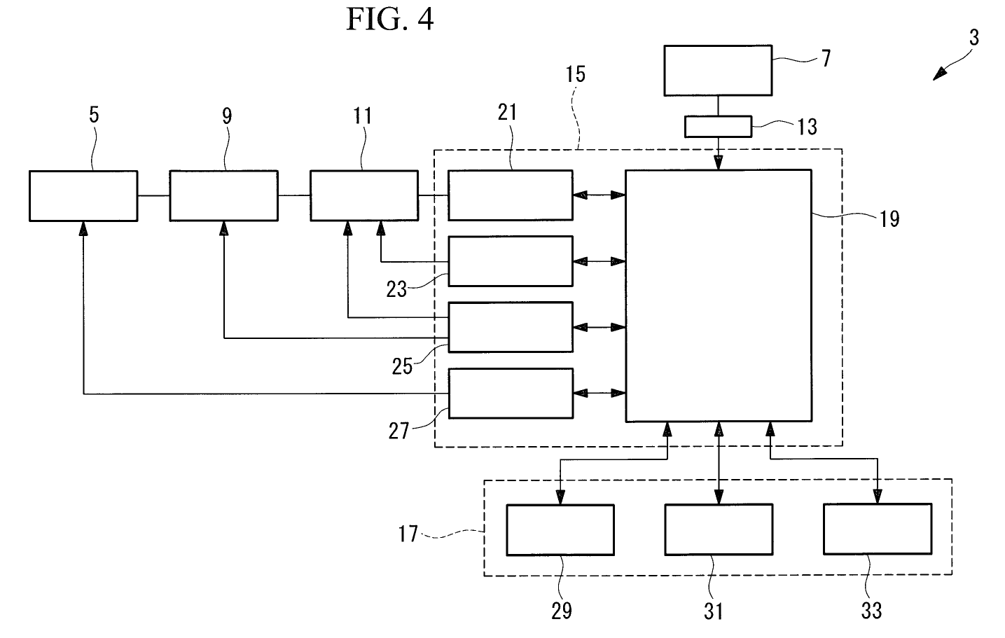

As shown in FIG. 4, the camera body 3 includes an image-acquisition device 9, such as a CCD, for acquiring the image of the subject formed by the lens unit 5; an analog front end (hereinafter simply referred to as “AFE”) 11 for converting analog image data acquired by the image-acquisition device 9 into digital image data after being subjected to gain processing in an analog gain amplifier, which is not shown in the drawing; a sensor (detector) 13 for detecting a control level of the shutter control member 7; a central controller 15 to which the control level obtained by the sensor 13 and the digital image data processed by the AFE 11 are input and which performs overall control of the entire apparatus; and a memory unit 17 for storing the digital image data input to the overall controller 15 as acquired image data.

The shutter control member 7 includes a frame-rate dial 7A, with a substantially cylindrical shape, having a rotation axis perpendicular to the top surface of the camera body 3, and a shutter button 7B which can be pressed in a direction perpendicular to the top surface of the frame-rate dial 7A.

The frame-rate dial 7A is disposed so that, when a user holds the digital camera 1 at both ends in the longitudinal direction thereof, the outer circumferential surface thereof is gripped with the thumb and index finger of the right hand, or the outer circumferential surface thereof is gripped with the thumb and middle finger of the right hand, with the index finger resting on the shutter button 7B, and part of the finger operating the shutter control member 7 contacts the front surface of the camera body 3.

By rotating the frame-rate dial 7A about the rotation axis thereof, the outer circumferential surface thereof is made to move in a direction along the front surface of the camera body 3. Then, the frame rate is changed by changing the charge transfer rate of the image-acquisition device 9 in proportion to the rotation angle of the frame-rate dial 7A.

Notches indicating a standard position and the frame rate of the image-acquisition device 9 are provided in the outer circumferential surface of the frame rate dial 7A. In addition, the frame rate dial 7A is biased with a spring (not shown in the drawing) so as to return to the standard position.

The stroke of the frame-rate dial 7A corresponds to a range defined by the upper limit and the lower limit of the frame rate.

The central controller 15 includes an overall controller (control unit) 19 for controlling the overall camera; a picture signal processing unit 21 for performing processing, such as color correction and JPEG compression, on the digital image data output from the AFE 11; a gain control unit 23 for controlling the AFE 11 on the basis of a control signal sent from the overall controller 19; a timing control unit 25 for controlling the image-acquisition device 9 and the AFE 11 on the basis of a control signal sent from the overall controller 19; and a lens-unit controller 27 for controlling the lens unit 5 on the basis of a control signal sent from the overall controller 19.

The memory unit 17 includes a buffer memory 29 for temporarily storing the acquired image data; a liquid crystal display 31 (hereinafter simply referred to as “LCD”) for displaying a region of image acquisition through the lens unit 5 and for displaying the acquired image data stored in the buffer memory 29; and a card interface 33 for saving the acquired image data stored in the buffer memory 29.

The operation of the digital camera 1 according to this embodiment, with the above-mentioned configuration, will now be described.

When the digital camera 1 according to this embodiment is started up, the subject imaged via the lens unit 5 is acquired by the image-acquisition device 9 and output as analog image data, and it is then converted to digital image data in the AFE 11. The image of the subject converted to digital image data is subjected to image processing in the picture signal processing unit 21 and is displayed on the LCD 31 via the central controller 15.

In this state, when the shutter button 7B of the shutter control member 7 is pressed by a prescribed amount, the gain control unit 23, the timing control unit 25, and the lens-unit controller 27 are operated on the basis of the digital image data of the subject output at that time from the picture signal processing unit 21 in the central controller 15. Accordingly, the lens unit 5, the image-acquisition device 9, and the AFE 11 are respectively controlled so that the acquired image has the correct exposure, and the analog image data of the subject is acquired in the image-acquisition device 9.

After the analog image data acquired in the image-acquisition device 9 is converted to digital image data in the AFE 11, it is output via the overall controller 19 to the buffer memory 29, where it is temporarily stored. By operating the overall controller 19, the digital image data stored in the buffer memory 29 can be displayed on the LCD 31 as a still image and saved using the card interface 33.

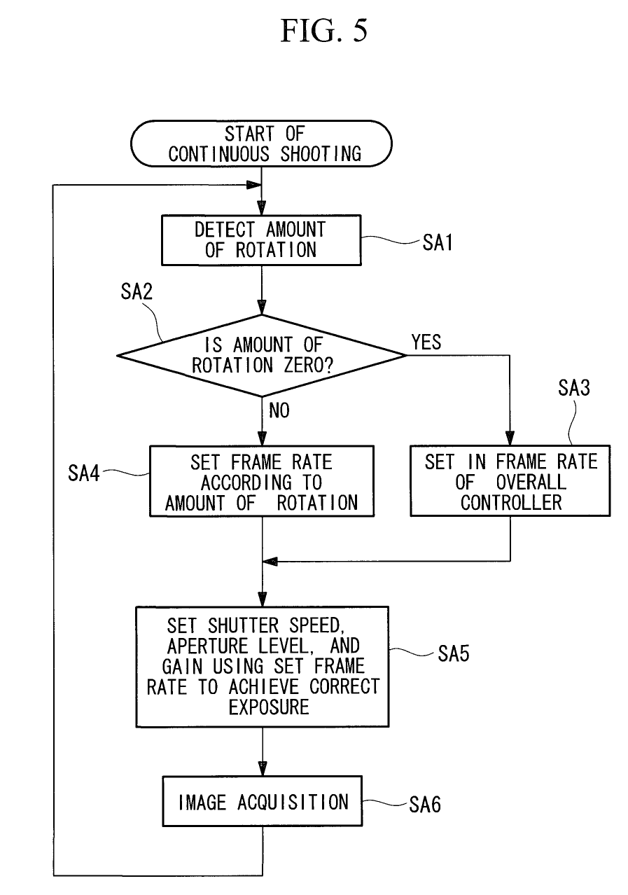

Next, the operation of the digital camera 1 according to this embodiment during continuous shooting photography will be described in detail using the flowchart shown in FIG. 5.

When the digital camera 1 according to this embodiment starts the image acquisition operation, the control level of the frame-rate dial 7A, in other words, the rotation angle thereof, is detected by the sensor 13 (Step SA1), and the detected signal is output to the overall controller 19.

A frame-rate value corresponding to the notches indicating the standard position and the frame rate of the image-acquisition device 9, which are inscribed on the outer circumferential surface of the frame-rate dial 7A, is calculated in the overall controller 19 on the basis of the detected signal input thereto. More specifically, when the rotation angle of the frame-rate dial 7A is zero, in other words, when the frame-rate dial 7A is positioned at notch 0, which is the standard position (“YES” at Step SA2), a standard frame-rate value which the overall controller 19 sets is output to the timing control unit 25 (Step SA3).

On the other hand, when the rotation angle of the frame-rate dial 7A is not zero, in other words, when the frame-rate dial 7A is at positions other than notch 0, for example, notch 5, notch 10, or notch 15 (“NO” at Step SA2), a frame-rate value corresponding to the number written at the notch is calculated, so that the frame rate of the image-acquisition device 9 changes to 5, 10, or 15 frames per second, etc.

In this case, when the calculated frame-rate value is small, the standard shutter speed is output to the timing control unit 25 together with the calculated frame-rate value. On the other hand, when the calculated frame-rate value is extremely large, it is necessary to increase the shutter speed; therefore, the required shutter speed is calculated in the overall controller 19 on the basis of the frame-rate value, and the calculated shutter speed is output to the timing control unit 25 together with the frame-rate value.

In the timing control unit 25, driving timing of the image-acquisition device 9 is set on the basis of the frame-rate value and the shutter speed input thereto (Step SA4), the frame-rate value is output to the AFE 11 as sampling timing, and a driving frequency of an analog-to-digital converter in the AFE 11 is set.

An aperture value and an ISO sensitivity value are also calculated in the overall controller 19 so that the acquired image has the correct exposure. The calculated aperture value is sent to the lens-unit controller 27, and the aperture level of the lens unit 5 is set by the lens-unit controller 27. The calculated ISO sensitivity is sent to the gain control unit 23, and it is set by the gain control unit 23 as a gain value of the gain amplifier in the AFE 11 (Step SA5).

Accordingly, the lens unit 5, the image-acquisition device 9, and the AFE 11 are controlled at the set frame-rate value so as to obtain the correct exposure, thus performing continuous shooting photography (Step SA6).

During the image-acquisition operation, the rotation angle of the frame-rate dial 7A is constantly detected by the sensor 13, and the operations in Steps SA1 to SA6 are repeated. For example, when the frame-rate dial 7A is rotated from the notch 0 position to a notch indicating a certain value, the frame rate set by the overall controller 19 is changed, and a new frame rate corresponding to the arbitrarily selected notch number is set.

In addition, when, for example, the frame-rate dial 7A is rotated clockwise from an arbitrarily selected notch number in a direction such that the number increases, the frame rate is controlled so as to increase accordingly. On the other hand, when the frame-rate dial 7A is rotated anticlockwise in a direction such that the notch number decreases, the frame rate is controlled so as to decrease accordingly. Thus, by rotating the frame-rate dial 7A about its rotation axis while holding it, it is possible to continuously change the frame rate during continuous shooting photography.

With the digital camera 1 according to this embodiment, because the frame rate is changed by a rotary operation of the frame-rate dial 7A, and the change is proportional to the rotation angle about the rotation axis of the frame-rate dial 7A, it is possible to ensure a large stroke in the direction in which it is operated.

Also, because the shutter control member 7 is operated while part of the finger used to operate it is kept in contact with the front surface of the camera body 3, the operating force applied by the finger is augmented by the friction force thereof, which facilitates fine adjustment and allows the shutter control member 7 to be held firmly. Therefore, it is possible to easily and precisely adjust the frame rate during continuous shooting photography. In addition, the user can easily ascertain the frame rate from the notch number on the frame-rate dial 7A.

This embodiment has been illustrated in terms of an example in which the frame rate is changed on the basis of the rotation angle of the frame-rate dial 7A. Instead of this arrangement, as the frame-rate dial 7A, it is possible to employ a structure whereby the operating force thereof varies according to the rotation angle, by using a spring or the like, and to change the frame rate on the basis of the operating force of the frame-rate dial 7A. In this case, the sensor 13 should detect the operating force of the frame-rate dial 7A.

This embodiment has been illustrated in terms of an example in which a programmed frame rate set by the overall controller 19 is set at the notch 0 position on the frame-rate dial 7A, and when the frame-rate dial is rotated clockwise, the frame rate is changed. In an alternative configuration, with the notch 0 position serving as a reference, when rotated clockwise, the programmed frame rate set by the overall controller 19 may be increased in proportion to the rotation angle, and when rotated anticlockwise, the programmed frame rate set by the overall controller 19 may be decreased in proportion to the rotation angle.

In this embodiment, the frame-rate dial 7A is biased by the spring so as to return to the standard position. Instead of this, however, the shutter control member 7 may include, for example, a friction joint (control-level maintaining unit) on a rotation shaft thereof, and the rotary position of the frame-rate dial 7A may be maintained by means of a frictional force thereof. By doing so, because the control level of the shutter control member 7 is maintained, it is possible to keep the frame rate constant, even when the user removes his or her hand from the shutter control member 7. Therefore, it is possible to perform continuous shooting photography with a stable frame rate setting, even though the shutter control member 7 is not operated continuously.

In this embodiment, the frame rate is changed in a stepwise manner according to the notches on the frame-rate dial 7A. However, it is possible, for example, to calculate the frame-rate value according to the position, even at a position between two notches, so as to change the frame rate in a gradual manner.

In this embodiment, the shutter control member 7 includes the frame-rate dial 7A and the shutter button 7B. However, the shutter control member 7 need not be provided with the shutter button 7B; instead, the frame-rate dial 7A itself may also function as the shutter button 7B.

In this case, when the frame-rate dial 7A is rotated, the analog image data of the subject should be acquired by the image-acquisition device 9 according to the frame-rate value therefor.

### Second Embodiment

A digital camera 101 according to a second embodiment of the present invention will be described below with reference to the drawings.

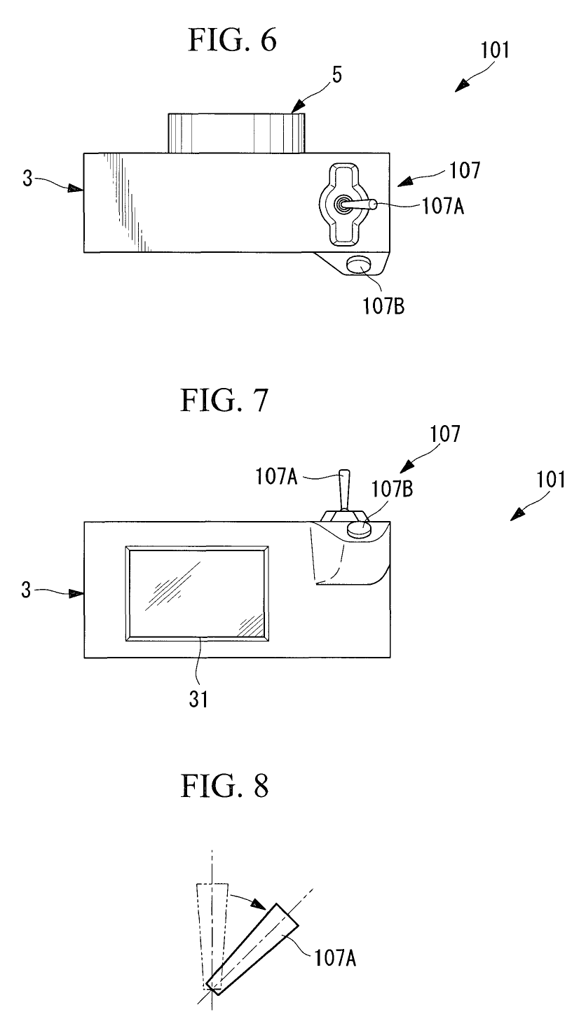

In the digital camera 101 according to this embodiment, the configuration of the shutter control member 107 differs from that in the first embodiment, as shown in FIGS. 6 and 7.

Elements having the same configuration as those in the digital camera 1 according to the first embodiment are assigned the same reference numerals, and a description thereof is omitted here.

The shutter control member 107 of the digital camera 101 includes a frame-rate stick 107A projecting upward from the top surface of the camera body 3. It also includes a shutter button 107B, capable of being pushed in perpendicularly, which is provided on a protruding portion in the surface at the LCD 31 side, close to the frame-rate stick 107A. The frame-rate stick 107A is provided in such a manner that the stick 107A can be rocked about a rotation axis near and in parallel with the top surface of the camera body 3 as shown in FIG. 8.

More specifically, when the user holds the digital camera 201 at both ends in the longitudinal direction thereof, the shutter button 107B and the frame-rate stick 107A are disposed so that the index finger loops around the frame-rate stick 107A, with the thumb of the right hand resting on the shutter button 107B. Accordingly, while pressing the shutter button 107B with his or her thumb, the user can tilt the frame-rate stick 107A towards the user or towards the subject with his or her index finger.

In addition, the frame rate set by the overall controller 19 is set with the frame-rate stick 107A in the upright position, and the frame rate is changed according to the tilt angle. More specifically, when the frame-rate stick 107A is tilted towards the user, the frame rate set by the overall controller 19 increases in proportion to the tilt angle. On the other hand, when the frame-rate stick 107A is tilted towards the subject, the frame rate set by the overall controller 19 decreases in proportion to the tilt angle.

The tilt-angle stroke of frame-rate stick 107A is within a range defined by the upper and lower limits of the frame rate. Also, the frame-rate stick 107A is urged with a spring (not shown in the drawing) so that it returns to the upright position relative to the top surface of the camera body 3. The frame-rate stick 107A may be provided in such a manner that the tilt angle thereof changes in a stepwise manner, so that the user can understand the control level. Additionally, in order for the user to more clearly understand the frame rate, the frame rate may be displayed on the LCD 31, for example.

The operation of the digital camera 101 according to this embodiment, having the above configuration, will now be described.

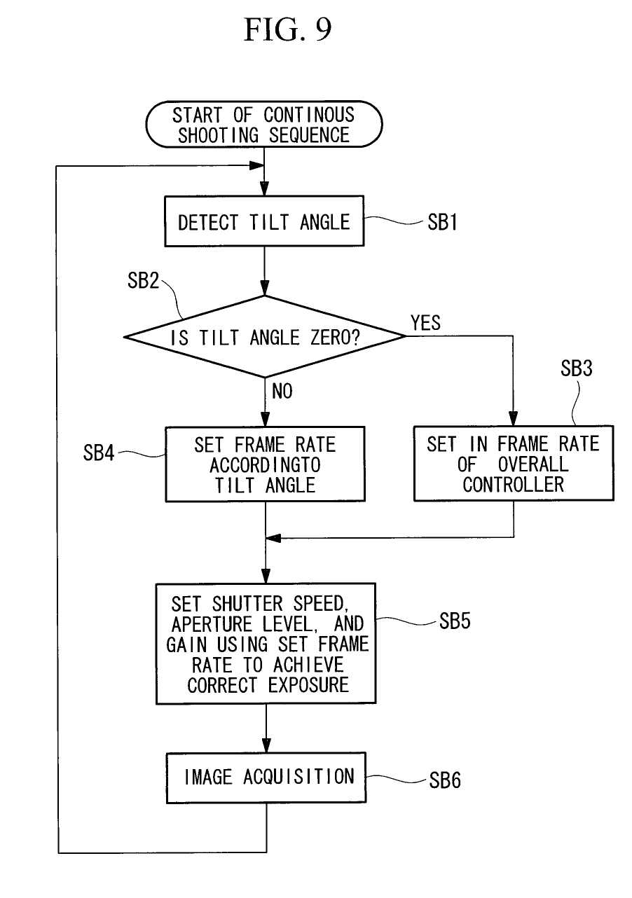

When the digital camera 101 according to this embodiment commences an image acquisition operation, as shown in FIG. 9, the control level of the frame-rate stick 107A, in other words, the tilt angle, is detected by the sensor 13 (Step SB1). If the tilt angle of the frame-rate stick 107A is zero (“YES” at Step SB2), a standard frame-rate value set by the overall controller 19 is output to the timing control unit 25 (Step SB3).

On the other hand, if the tilt angle of the frame-rate stick 107A is not zero, in other words, if a tilt angle is detected at the sensor 13 (“NO” at step SB2), a frame-rate value is calculated in the central controller 15 on the basis of the detected tilt angle.

Accordingly, the lens unit 5, the image-acquisition device 9, and the AFE 11 are controlled at the set frame-rate value so as to achieve correct exposure, and continuous shooting photography is performed (Step SB6).

During image acquisition, the tilt angle of the frame-rate stick 107A is constantly detected by the sensor 13, and the operations in Steps SB1 to SB6 are repeated. For example, when the frame-rate stick 107A is tilted backward, the frame rate is controlled so as to increase in response thereto, and when the frame-rate stick 107A is tilted towards the subject, the frame rate is controlled so as to decrease in response thereto.

As described above, with the digital camera 101 according to this embodiment, by tilting the frame-rate stick 107A, the frame rate is changed in proportion to the tilt angle thereof. Therefore, it is possible to ensure a large stroke in the direction in which the frame-rate stick 107A is operated.

This embodiment has been illustrated in terms of an example in which the frame rate is increased when the frame-rate stick 107A is tilted backward and is decreased when the frame-rate stick 107A is tilted towards the subject. However, it is not limited to this configuration, so long as the frame rate is increased when the frame-rate stick 107A is tilted in one direction from the upright position and is decreased when the frame-rate stick 107A is tilted in the other direction.

This embodiment has been illustrated in terms of an example in which the frame rate is changed on the basis of the tilt angle of the frame-rate stick 107A. Instead of this, however, the frame rate may be changed on the basis of the operating force of the frame-rate stick 107A, in other words, the operating force during tilting. For example, the frame rate may increase as the pressing force tilting the frame-rate stick 107A to the right increases, and the frame rate may decrease as the pressing force tilting the frame-rate stick 107A to the left increases. In this case, the sensor 13 should detect the operating force on the frame-rate stick 107A.

In this embodiment, the frame-rate stick 107A is biased in an upright position with respect to the top surface of the camera body 3 by the action of the spring. Instead of this, however, the frame-rate stick 107A may be held in a tilted position.

In this embodiment, the shutter control member 107 includes the frame-rate stick 107A and the shutter button 107B. However, the shutter control member 107 need not be provided with the shutter button 107B; the frame-rate stick 107A itself may also serve the function of the shutter control member 106.

In this case, if the frame-rate stick 107A is tilted from the upright position with respect to the top surface of the camera body 3, analog image data of the subject should be acquired by the image-acquisition device 9 according to the tilt angle thereof.

Embodiments of the present invention have been described above with reference to the drawings; however, the specific configuration is not limited to these embodiments. Various modifications are possible so long as they do not depart from the spirit of the invention.

For example, instead of the frame-rate stick 107A of the shutter control member 107, the digital camera 101 according to the second embodiment may include a frame-rate slider that can move in a direction along the front surface of the camera body 3. In this case, for example, with the frame-rate slider provided so as to be slidable in one direction, when the frame-rate slider slides one way, the frame rate should increase as the sliding distance increases, and when the frame-rate slider slides the other way, the frame rate should decrease. In addition, a ball plunger or the like may be provided for maintaining the sliding position of the frame-rate slider, to maintain the control level of the shutter control member 107.

In the embodiments described above, the lens unit 5, the image-acquisition device 9, and the AFE 11 are controlled with the set frame-rate value so as to achieve the correct exposure. However, it is not always necessary to change all them, that is, the shutter speed, the aperture value, and the ISO sensitivity. Any one of the shutter speed, the aperture value, and the ISO sensitivity may be changed so as to obtain the correct exposure.

What is claimed is:

1. A camera comprising:
an image-acquisition device configured to acquire an image of a subject;
a shutter control member operated in a direction along a front surface of a casing during continuous shooting photography;
a detector configured to detect a control level or operating force of the shutter control member; and
a control unit configured to adjust a frame rate of the continuous shooting photography by the image-acquisition device on the basis of the control level or operating force detected by the detector.

2. A camera according to claim 1, wherein:
the detector detects the control level of the shutter control member; and
the shutter control member includes a control-level maintaining unit configured to maintain the control level.

3. A camera according to claim 1, wherein the shutter control member is a dial that is capable of rotating about an axis substantially orthogonal to the front surface of the casing.

4. A camera according to claim 1, wherein the shutter control member is a stick that is capable of rocking about an axis substantially parallel to the front surface of the casing.

5. A camera according to claim 1, wherein the shutter control member is a slider.
